(19) United States
(12) Patent Application Publication
(10) Pub. No.: US 2004/0112228 A1
(43) Pub. Date: Jun. 17, 2004

(54) Tortilla serving tray and support apparatus

(76) Inventors: Jonathan Nash, JR., Carter Lake, IA (US); Aaron R. Easley, Minneapolis, MN (US)

Correspondence Address: MERCHANT & GOULD PC, P.O. BOX 2903, MINNEAPOLIS, MN, 55402-0903, US

(21) Appl. No.: 10/322,144

(22) Filed: Dec. 17, 2002

(51) Int. Cl. A23P 1/00

(52) U.S. Cl. 99/450.1

(57) ABSTRACT

The present invention comprises a tortilla serving tray and support apparatus, configured of a hard plastic or other material having a top wall and sidewalls, wherein the top wall has at least one tortilla receiving cavity and at least one tortilla receiving chamber formed therein, into which tortillas are positioned and supported by the at least one tortilla receiving cavity and at least one tortilla receiving chamber wherein each has a base wall connected to a sidewall that extends up the interior of the tortilla receiving chamber until it ends at the top wall.

### TECHNICAL FIELD

This application generally relates to a dinning support apparatus for transporting and supporting tortillas such as tacos, tortillas, fajitas, wraps, gorditas, chalupas, burritos, enchiladas and the like.

### BACKGROUND

Mexican food, particularly those dishes that utilize tacos and tortillas, has become very popular in the United States. The Mexican foods market, including the fast food, dine-in/sit down restaurant and the home production and consumption segments, has grown into a multi-billion dollar industry. Many individuals enjoy the fast food and restaurant version of Mexican taco and tortilla-based dishes, while many others prefer to construct their taco and tortilla-based dishes at home using fresh ingredients. However, the nature of many popular taco and tortilla dishes present several undesirable problems for taco and tortilla preparers and consumers.

One such problem encountered in preparation of tacos and tortillas is that, since taco shells have a rounded base and tortillas revert to a flat disc shape when not held in hand, it is very difficult to support taco shells and tortillas in an upright or manageably stable position while filling the taco and tortilla, respectively, with the desired ingredients, such as meat, beans, vegetables, and/or salsa, etc. Unfortunately, the taco and tortilla builder's effort often results in a mess wherein many of the taco ingredients end up outside the taco shell or in unmanageable proportions on tortillas during the construction process. There is therefore a need for a taco shell and tortilla support device, which will support tacos and tortillas in a position to reduce waste and mess and simplify the taco and tortilla filling process.

Moreover, following preparation of tacos and tortillas, tacos are presented on their side on a plate. This can lead to much of the taco filling falling out of the taco shell onto the plate. When tortillas are presented on a plate, they lay open and are presented as a mound of ingredients that tend to distribute all over the tortilla, thus causing the loss of tortilla fillings when the consumer picks up the tortilla filled with ingredients. Tacos and tortillas are currently transported and supported by plates or papers. It may also be supported and transported by an apparatus such as that disclosed in U.S. Pat. No. 6,019,224. When paper or plates are used as transport or support devices, they yield the undesirable need for action by the food consumer to replace or redistribute the taco and tortilla fillings in the tortilla shell. Further, the presentation of tacos and tortillas on paper or plates is not the most aesthetically pleasing method and could subtract from the entire eating experience. Presentation may also be an issue in venues where a large number of tacos are to be served to a group of individuals, such as at a party or at a restaurant.

Accordingly, there is a need for an improved tortilla support and transport apparatus. The present invention provides a solution to many problems, such as those discussed above, currently faced in the industry.

### SUMMARY

A tortilla tray and support apparatus, configured of a hard plastic or other material having a top wall and sidewalls, wherein the top wall has at least one tortilla receiving cavity and at least one tortilla receiving chamber formed therein, into which tortillas are positioned and supported by the at least one tortilla receiving cavity and the at least one tortilla receiving chamber wherein each is comprised of a base wall connected to a sidewall that extends around the interior of the tortilla receiving chamber. In alternative embodiments the tortilla support apparatus may include tortilla support chambers only in other embodiments the tortilla support apparatus may include tortilla-receiving chambers only. In one embodiment, the tortilla tray and support apparatus includes sections that are removable. In another embodiment, the tortilla tray and support apparatus may include sections that fold upward and downward. In another embodiment the tortilla support apparatus may be rotated about a central axis.

These and various other features as well as advantages which characterize the present invention will be apparent from a reading of the following detailed description and a review of the associated drawings.

### BRIEF DESCRIPTION OF THE DRAWINGS

FIG. 1 illustrates one embodiment of a tortilla support tray according to an embodiment of the present inventions;

FIG. 2 illustrates another embodiment of a tortilla support tray;

FIG. 3 is a sectional view of the tortilla tray shown in FIG. 2;

FIG. 4 is a top view of the tortilla tray illustrated in FIG. 2 showing the foldable exterior edges folded on top of the center portion of the tortilla tray;

FIG. 5 is a cross sectional view of the tortilla tray illustrated in FIG. 4;

FIG. 6 is a cross sectional view of the tortilla tray illustrated in FIG. 4, wherein a dovetail interlock system has been implemented to facilitate the removability of the exterior portions;

FIG. 7 is a sectional cut away top view of the tortilla tray dovetail interlock;

FIG. 8 is a cross sectional view of the tortilla tray illustrated in FIG. 4, wherein bypassing ribs has been implemented to facilitate folding of the exterior portions;

FIG. 9 is a sectional cut away top view of the tortilla tray bypassing ribs;

FIG. 10 is a top view of an alternative embodiment tortilla tray;

FIG. 11 is a top view of an alternative embodiment of a tortilla tray;

FIG. 12 is a partial cross section of the tortilla tray illustrated in FIG. 11 showing the moat-like storage area;

FIG. 13 illustrates an embodiment of a tortilla support device;

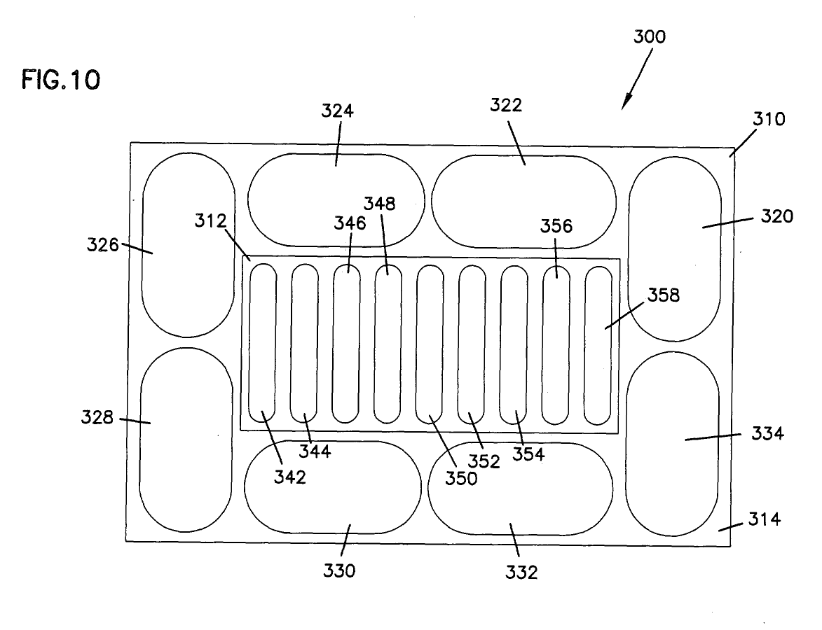

FIG. 10 is an alternative embodiment of a tortilla support device;

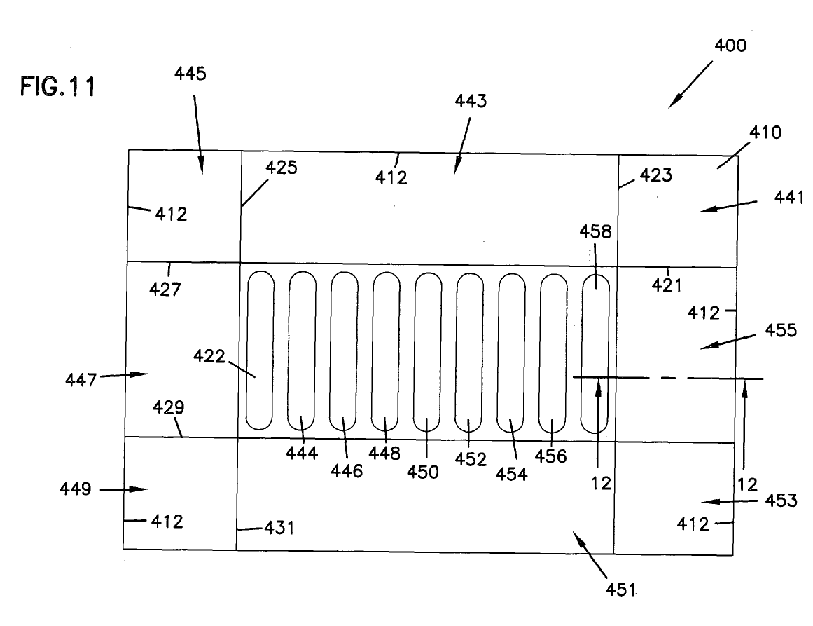

FIG. 11 is a cross sectional view of the tortilla support device illustrated in FIG. 10;

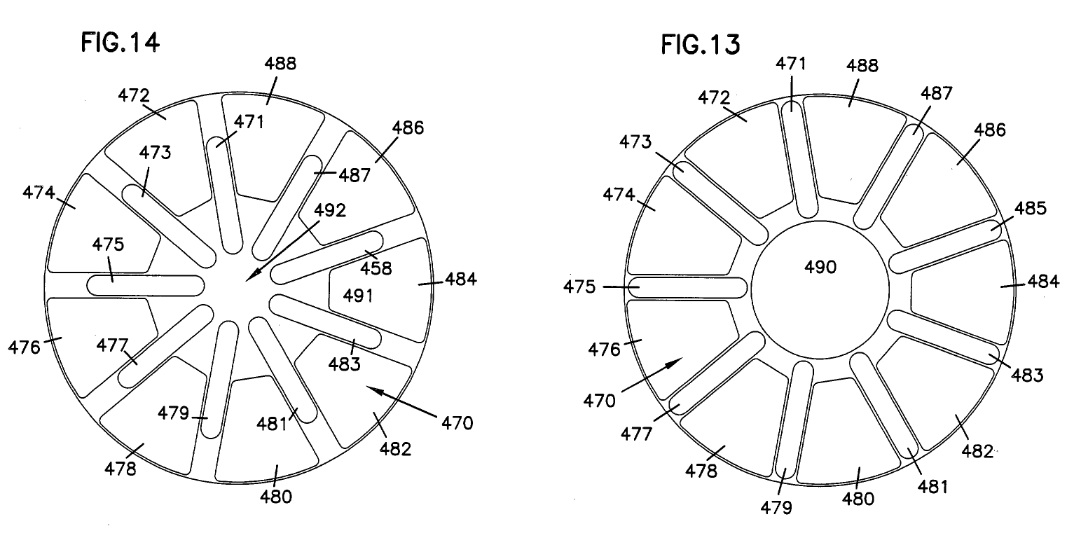

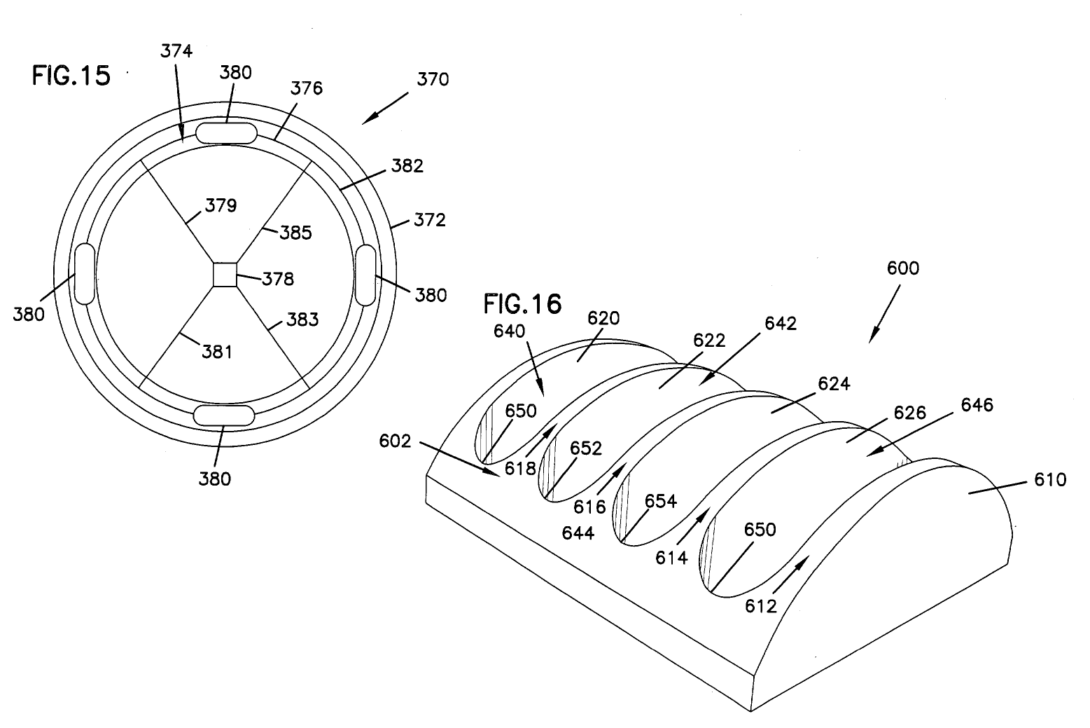

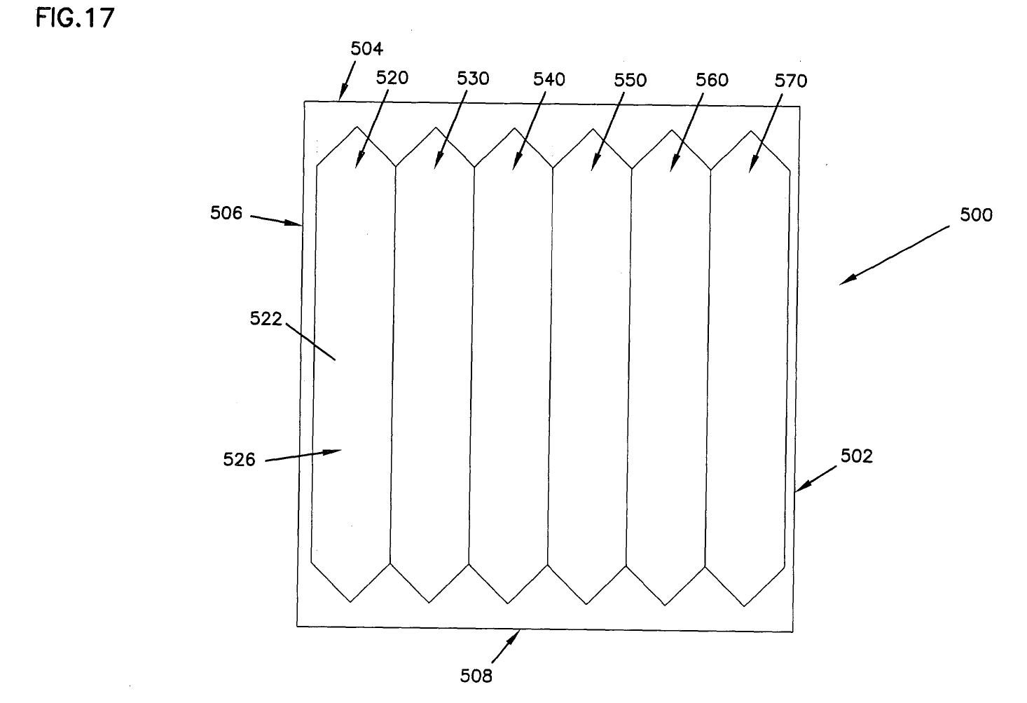

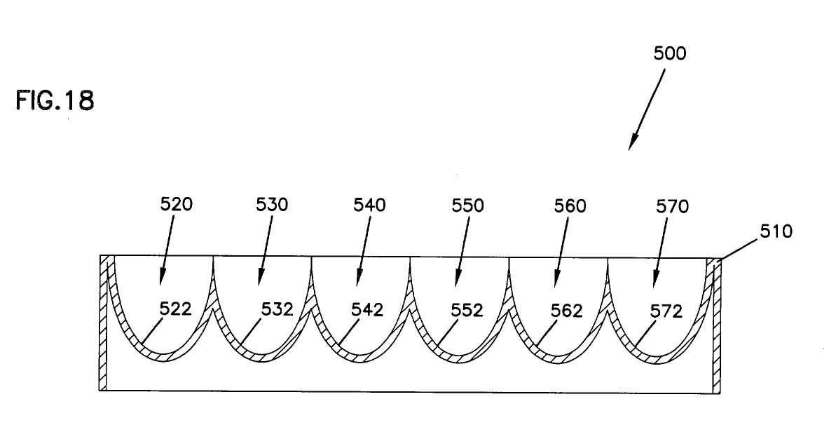

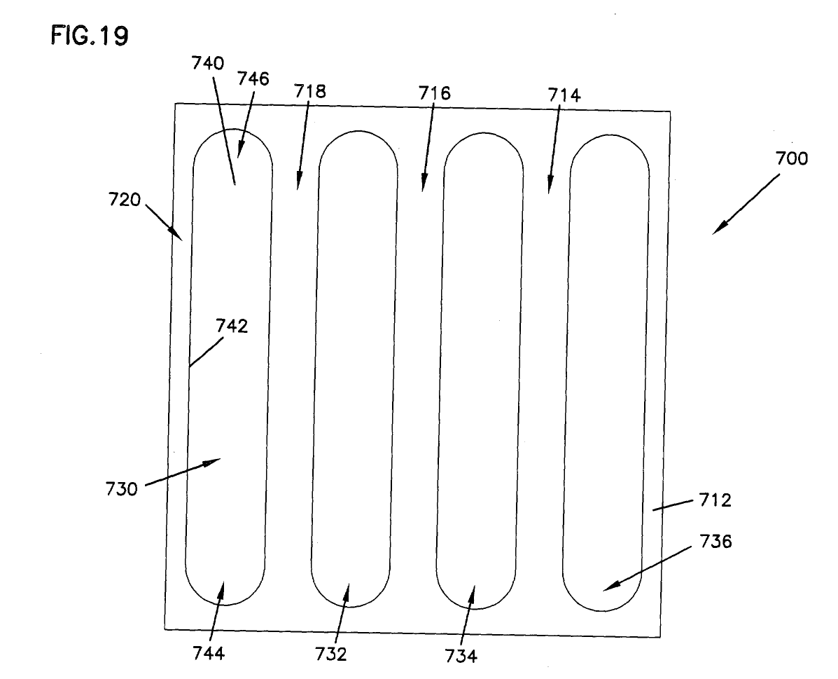

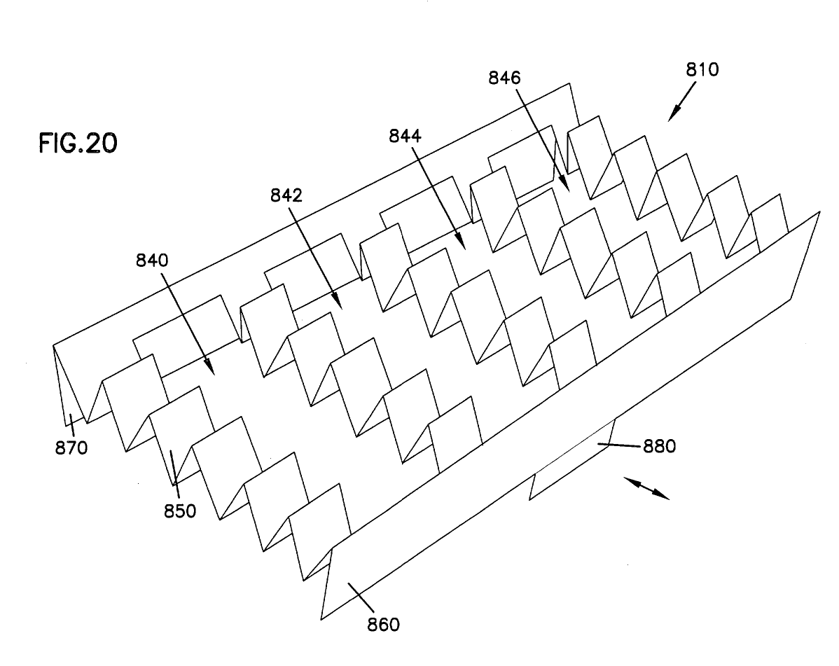

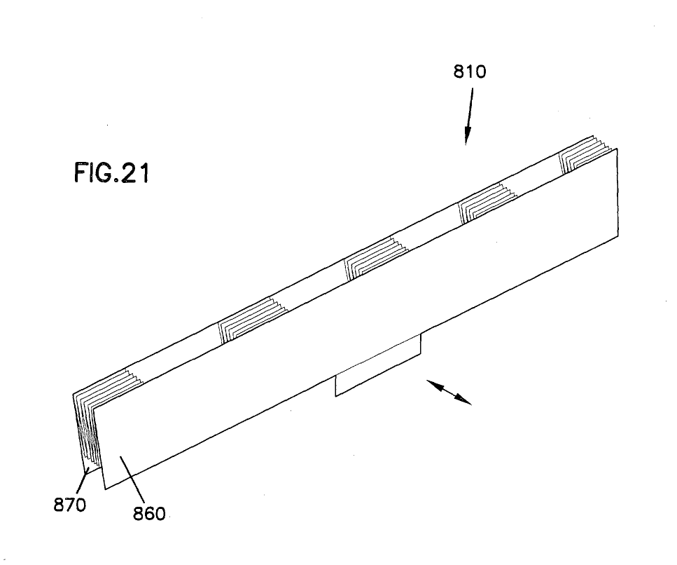

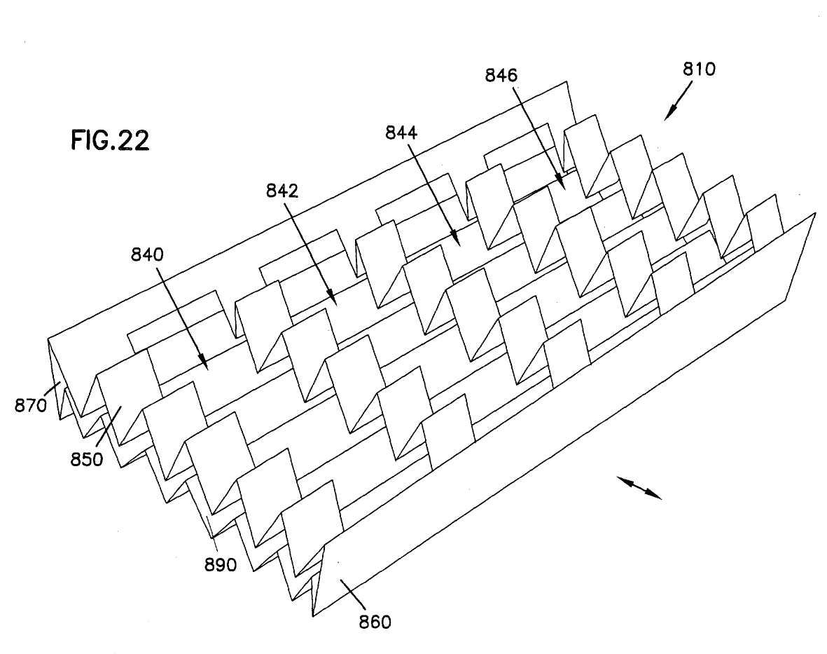

FIG. 13, is an alternative embodiment of the tortilla tray wherein the body of the tray is circular;

FIG. 14, is an alternative embodiment of the tortilla tray wherein the body of the tray is circular;

FIG. 15, is a top view of the rotational assembly used in combination with the tortilla trays illustrated in FIGS. 13 and 14 and allows the trays to be rotated about a center axis;

FIG. 16 is yet another alternative embodiment of a tortilla support device;

FIG. 17 is yet another alternative embodiment of a tortilla support device;

FIG. 18 is a cross section of the tortilla support device illustrated in FIG. 17;

FIG. 19 is yet another alternative embodiment of a tortilla support device;

FIG. 20 illustrates yet another embodiment of a collapsible tortilla support device that collapses laterally in an accordion style;

FIG. 21 illustrates the embodiment of the tortilla support device illustrated in FIG. 20 showing the laterally collapsible accordion style support device in its fully collapsed position; and

FIG. 22 illustrates yet another embodiment of a collapsible tortilla support device that collapses laterally in an accordion style.

### DETAILED DESCRIPTION

The present invention is a tortilla-serving tray configured such that it performs as a tortilla support apparatus that provides support to tortillas. The present invention is configured to provide vertical support to some tortillas and lateral support to others where needed through the use of tortilla receiving chambers and tortilla supporting cavities. As used herein, the definition of the term “tortilla” refers to and comprises hard U-shaped shells, soft taco shells, fajita wraps, gorditas, challupas, burritos, enchiladas and any other edible soft or hard shell food support device resembling hard and soft shell tacos, fajitas, gorditas, challupas, burritos, enchiladas and wraps. In one embodiment of the invention, the tortilla tray initially performs as a tortilla-serving device and is configured to provide support to tortillas in a vertical upright position or a lateral position. The tortilla tray is configured to provide lateral support to soft tortillas and wraps through the use of tortilla supporting cavities. The tortilla tray also includes tortilla-receiving chambers configured for supporting hard and soft shell tacos and other tortillas in a vertical upright position. The tortilla supporting cavity of the tortilla tray is a shallow support cavity built into the top plate of the tortilla tray to provide support for soft tortillas including fajita wraps, or any other soft taco and/or tortilla that when positioned on a surface it loses its U-shape or wrap configuration and reverts back to its original flat pancake-like form. The tortilla supporting cavities may also be used as separate storage areas for taco ingredients such lettuce, tomatoes, meat, salsa, sour cream, cheese, etc. In one embodiment, the tortilla tray has the tortilla receiving chambers located at the center of the tortilla tray within a tortilla tray interior portion and the tortilla supporting cavities positioned on an exterior portion surrounding the tortilla tray interior portion and the tortilla receiving chambers. In an alternative embodiment, the tortilla supporting cavities may be located at the center of the tortilla tray and positioned on the tortilla tray interior portion. The tortilla tray interior portion would then be surrounded by an exterior portion having tortilla-receiving chambers positioned thereon. Alternatively, the above embodiments are configured such that the exterior portion is a winged assembly whereby each individual wing portion is collapsible. The exterior collapsible wing portions fold upward and downward, thereby making the tortilla-receiving tray smaller for more efficient storage. Alternatively, the exterior wing portions are removable, whereby each wing portion engages the interior portion to expand the tortilla tray.

In another embodiment, the centrally located tortilla receiving chambers or tortilla receiving cavities positioned on an interior portion may be surrounded by an exterior portion comprising a moat-like spillage area or an ingredient component area. In this embodiment, spillage of tortilla condiments may be captured and held in the moat-like spillage area until the conclusion of a meal or the moat-like area can be used as a separate component area for taco ingredients such lettuce, tomatoes, meat, salsa, sour cream, cheese, etc. In another embodiment, the tortilla tray is a tortilla support device comprised of a non-collapsible rectangular box having a top wall, and four sidewalls connected thereto. Within the top wall of the rectangular box, a plurality of tortilla receiving chambers is formed, whereby each tortilla-receiving chamber has an elongated shape sized and configured to receive tortillas. In this embodiment, each tortilla-receiving chamber is spaced apart. Alternatively, each tortilla-receiving chamber is positioned adjacent the other whereby the sidewalls of each tortilla-receiving chamber are angled and connect at the edges to create accordion style effect for the plurality of tortilla receiving chambers adjacently positioned. In another embodiment, the tortilla support device comprises a rectangular box having four sidewalls connected thereto and a top wall connected to each of the four sidewalls. In this embodiment, each tortilla receiving chamber is spaced apart and the top wall into which the tortilla receiving chambers are formed is oval shaped. Within each tortilla-receiving chamber there are sidewalls connected to a base wall to create a leak-proof chamber into which tortillas are positioned.

In another embodiment, the tortilla support tray is a circular tray having a sidewall, top wall, bottom wall and rotational support apparatus. The top wall has tortilla receiving chambers and tortilla supporting cavities formed therein. The bottom wall is configured to engage the rotational support cavity that is comprised of a base plate and a wheel and spoke rotational assembly. The wheel and spoke rotational assembly engages the base plate and the bottom wall of the tortilla support device to facilitate rotation of the tortilla support tray.

In another embodiment, the tortilla support device is a laterally collapsible device comprised of paper or thin flexible plastic having at least two sidewalls, a top wall and a bottom wall. The top and bottom walls folds laterally in an accordion style manner allowing the top and bottom walls to compress laterally so that the two side walls are separated by a collapsed top and bottom wall when the tortilla support device is completely collapsed. In an alternative embodiment, the laterally collapsible tortilla support has two sidewalls and a top wall only. The two side walls each includes a stabilization tab that may be removably attached to a table, plate or piece of paper by way of an adhesive on one side of the stabilization tab.

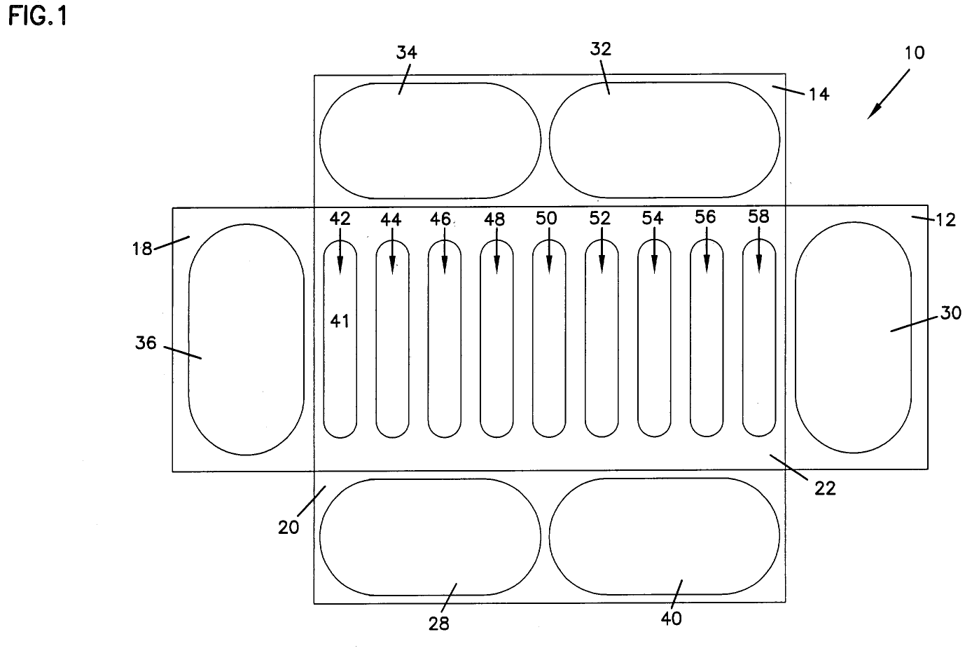

FIG. 1 illustrates one embodiment of the invention, illustrating a tortilla tray configured for providing vertical and lateral support to tortillas. In this embodiment, the tortilla tray 10 includes a tortilla tray inner-portion 22 and first, second, third and fourth exterior tray portions 12, 14, 18 and 20 permanently attached to the tortilla tray interior portion 22. In an alternative embodiment, the first, second, third and fourth exterior tray portions 12, 14, 18 and 20 are removably attached to the tortilla tray interior portion 22. In the embodiment illustrated in FIG. 1, the tortilla tray 10 is comprised of a hard material and is not collapsible. In the preferred embodiment, the hard material of which the tortilla tray 10 is comprised is plastic. Notwithstanding, it is to be understood that the present invention is not limited to being comprised of plastic. It is contemplated that the present embodiment of the invention may be implemented with sturdy paper, metal, wood, ceramic or any other material having the composition necessary to perform as food support. Is also contemplated in some embodiments, that material of which the tortilla tray 10 is comprised is heat resistant up to a point that would allow the tortilla tray 10 to be cleaned in a dishwasher. In other embodiments the material of which the tortilla tray is comprised may be heat resistant up to a temperature that would allow the tortilla tray to be used in an oven.

Each tortilla tray exterior portion 12, 14, 18 and 20 includes at least one tortilla supporting cavity, 30, 32, 34, 36, 38, and 40. The tortilla supporting cavities 30, 32, 34, 36, 38, 40 provide a shallow bowl-like support structure to soft shell tacos, fajitas, burrito, enchiladas, wraps and the like. The tortilla supporting cavities 30, 32, 34, 36, 38, 40 may also be used as separate storage areas for taco ingredients such lettuce, tomatoes, meat, salsa, sour cream, cheese, etc. The tortilla tray interior portion 22 includes a plurality of tortilla receiving chambers 42, 44, 46, 48, 50, 52, 54, 56, 58, that provide vertical support to hard U-shaped tacos and soft tacos and any other tortilla requiring vertical support. The support within each of the tortilla receiving chambers 42, 44, 46, 48, 50, 52, 54, 56, 58, is provided by a sidewall and base wall (not shown) that will provide the requisite support to the tortilla positioned within the tortilla receiving chambers 42, 44, 46, 48, 50, 52, 54, 56, 58. Referring to tortilla receiving cavity 42 in FIG. 1, the sidewall 41 extends around the entire tortilla-receiving chamber 42 and is about one to two inches high at every point. The sidewall 41 is connected directly to a base wall (not shown), which acts as the floor of the tortilla-receiving chamber 42.

In an alternative embodiment, the tortilla tray interior portion 22 may include tortilla-supporting cavities such as the shallow bowl-like support structures illustrated in FIG. 1. With tortilla supporting cavities positioned on the tortilla tray interior portion, the first, second, third and fourth exterior tray portions 12, 14, 18 and 20 would include tortilla receiving chambers such as those described above in reference to FIG. 1. In another alternative embodiment, the tortilla tray interior portion 22 and the tortilla tray exterior portions 12, 14, 18 and 20 may include both tortilla-supporting cavities and tortilla receiving chambers.

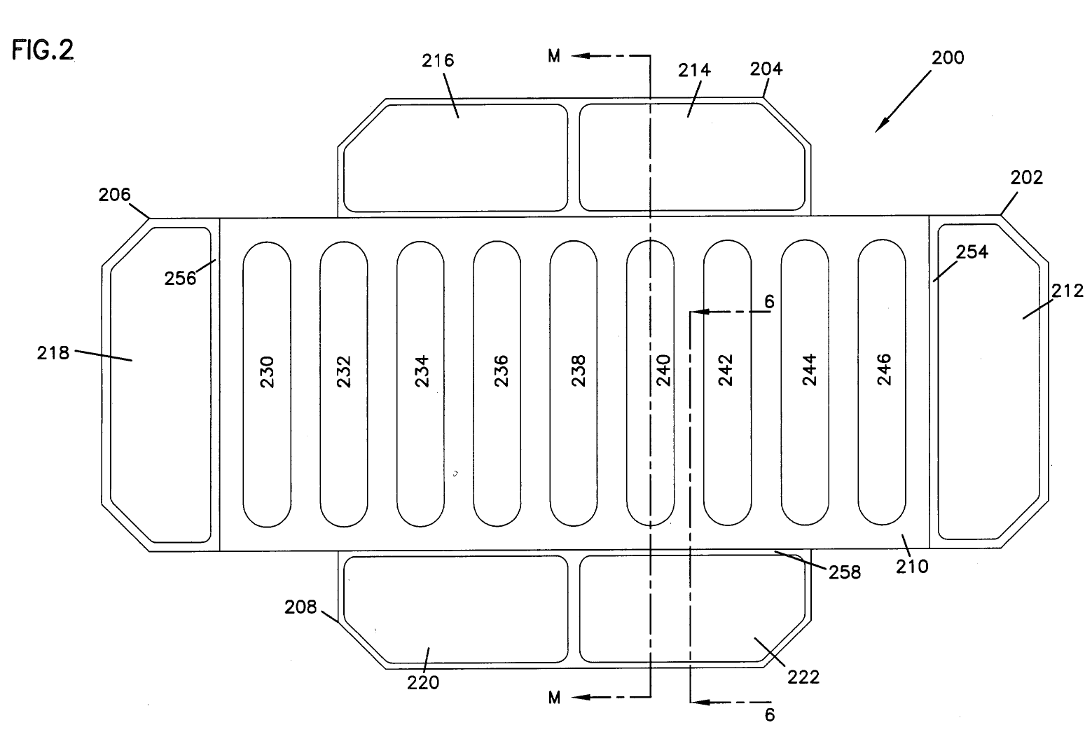

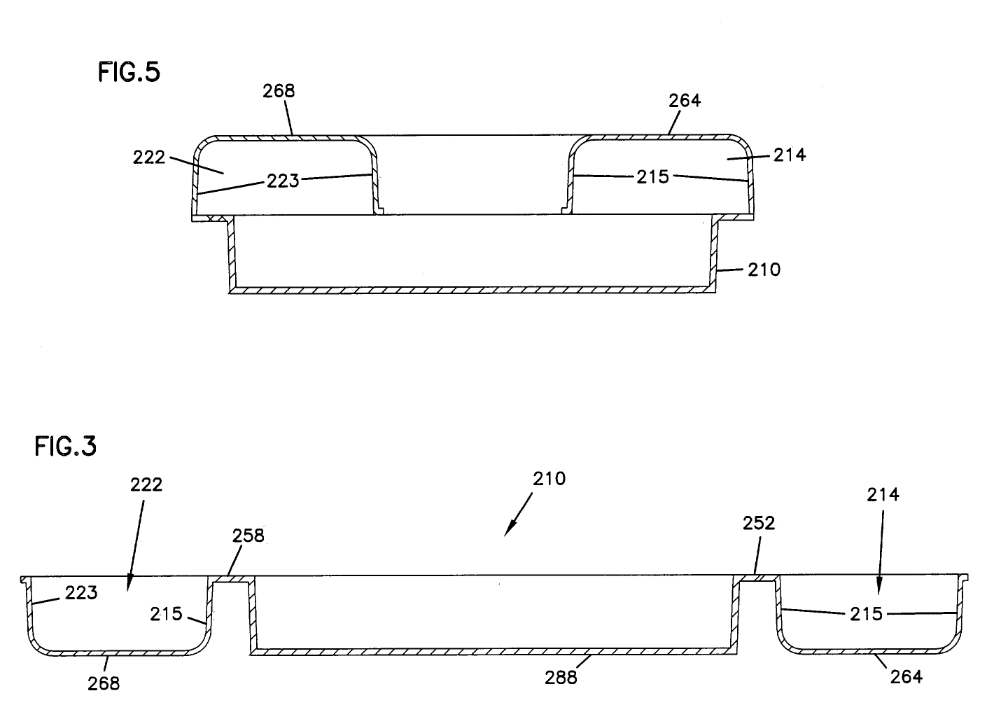

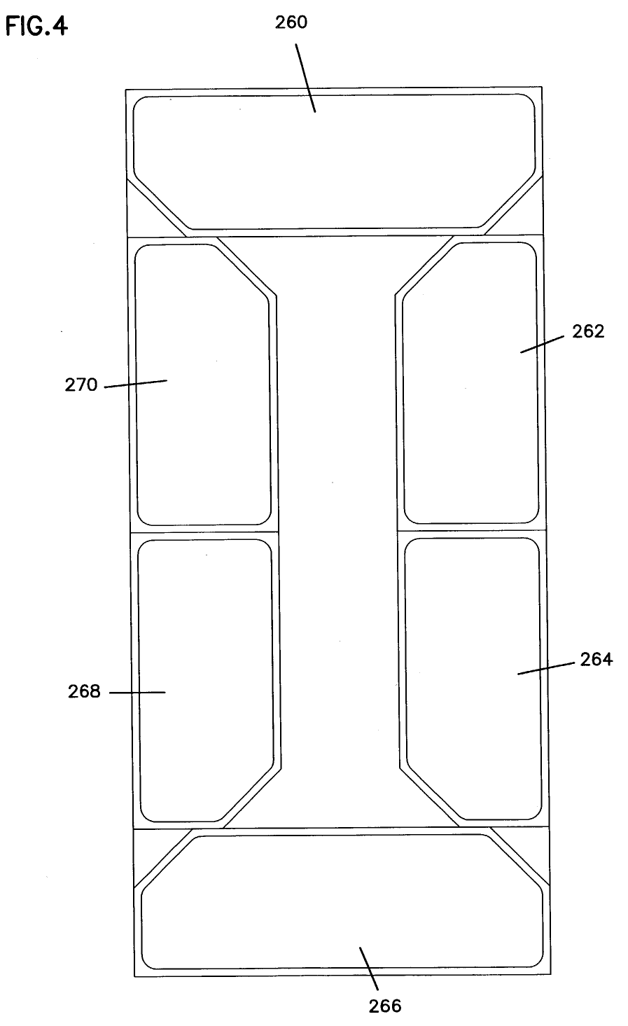

FIG. 2 illustrates an alternative embodiment of a tortilla tray 200. In the embodiment illustrated in FIG. 2, the tortilla tray 200 has foldable exterior portions 202, 204, 206 and 208, which provide for more efficient storage. The foldable exterior portions 202, 204, 206 and 208 fold downward and upward onto an interior portion 210 of the tortilla tray 200 as illustrated in FIG. 4. The first, second, third and fourth exterior tray portions 202, 204, 206, 208 are connected to the interior portion 210 of the tortilla tray 200 via integral living hinges 252, 254, 256 and 258. The integral living hinges 252, 254, 256, 258 in the present embodiment are a thin flexible plastic that hingedly connects the first, second, third and fourth exterior tray portions 202, 204, 206 and 208 to the interior tray portion 210. Each exterior tray portion includes at least one shallow bowl-like tortilla-supporting cavity. The first tortilla tray exterior portion 202 has one shallow bowl-like tortilla-supporting cavity 212. In alternative embodiments, the number of tortilla receiving cavities positioned on a tortilla exterior tray portion may be greater, depending on the size of the shallow bowl-like tortilla supporting cavity and the relative size of the tortilla tray 200. In the present embodiment, the shallow bowl-like tortilla supporting cavities are about five inches long and about one-half inches deep. Notwithstanding, it is contemplated that the tortilla supporting chambers and tortilla supporting cavities could be of varying sizes and still be within the scope of the invention. The second tortilla tray exterior portion 204 includes two shallow bowl-like tortilla-supporting cavities 214 and 216. The third tortilla tray exterior portion 206 has one shallow bowl-like tortilla-supporting cavity 218. The fourth tortilla tray exterior tray portion 208 includes two shallow bowl-like tortilla-supporting cavities 220 and 222. The tortilla tray interior portion 210 has tortilla-receiving chambers 230, 232, 234, 236, 238, 240, 242, 244, 246 formed into the body of the tortilla tray interior portion. Each tortilla-receiving chamber is comprised of a vertical sidewall that extends around the entire tortilla-receiving chamber and a bottom wall that creates the tortilla-receiving chamber. As illustrated in FIGS. 3 and 5, the shallow bowl-like tortilla supporting cavities 214 and 222 include sidewalls 223 and 215 that extend around the entire shallow bowl-like tortilla supporting cavities 214, 222, into which tortillas are placed.

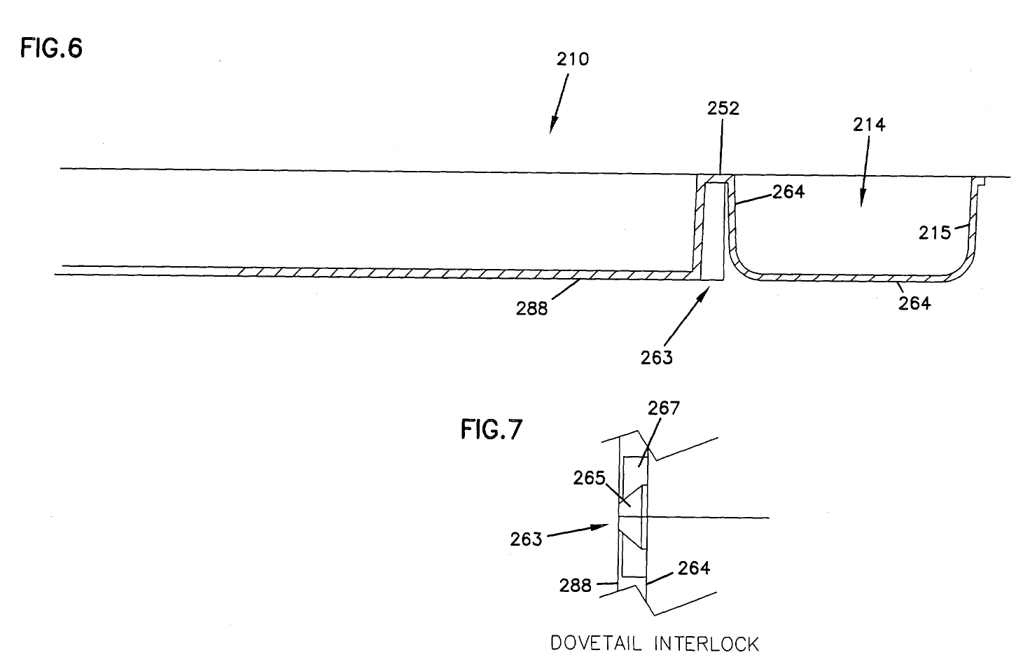

Referring to FIG. 2, an alternative embodiment of the tortilla tray 200 is configured such that the first, second, third and fourth exterior tray portions 12, 14, 18 and 20 are removably attached to the tortilla tray interior portion 22 by way of a dove tail interlock. FIGS. 6 and 7 illustrate the dovetail interlock device 263 that stabilizes the tortilla tray exterior portions 202, 204, 206, 208 and keeps them attached to the tortilla tray interior portion. As illustrated in FIG. 6 and 7, the dovetail stabilization apparatus 263 is comprised of a male 265 female 267 interlock. The male portion 265 of the dovetail interlock device 263 is attached to the exterior 288 of the interior portion 210. The female portion 267 of the dovetail interlock device 263 is attached to the exterior 264 of the exterior tray portion 214.

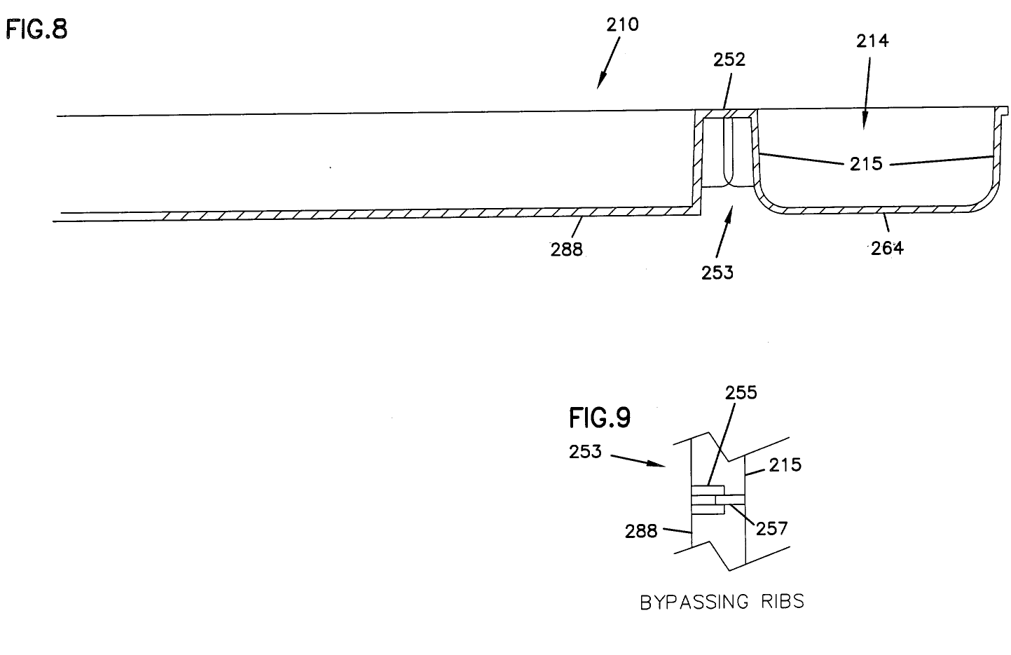

Referring to FIG. 2 an alternative embodiment of the tortilla tray 200 is configured such that the first, second, third and fourth exterior tray portions 12, 14, 18 and 20 are hingedly attached to the interior tray portion 210 and stabilized by a bypassing rib assembly 253 as illustrated in FIGS. 7 and 8. It can be seen that when the tortilla tray 200 is positioned on a flat surface, that the interior portion 210 and the exterior portions 202, 204, 206, 208 are on the same lateral plane. Notwithstanding, when the tortilla tray is lifted off of the surface, because the first, second, third and fourth exterior tray portions 202, 204, 206, 208 are hingedly connected to the interior portion 210 of the tortilla tray 200 via integral living hinges 252, 254, 256 and 258, there is a need for stabilization support that will prevent the exterior portions 202, 204, 206, 208 from collapsing downward. As illustrated in FIG. 7 and 8, the bypassing rib assembly 253 stabilizes the exterior tray portions so that these exterior tray portions do not fall downward. The bypassing rib assembly 253 is comprised of a male 257 and female 255 portions of a bypassing rib assembly. The male portion 257 of the bypassing rib assembly 253 is attached to the exterior 288 of the interior portion 210. The female portion 267 of the bypassing rib assembly 253 is attached to the exterior 264 of the exterior tray portion 214.

FIG. 10 illustrates another embodiment of a tortilla tray 300 having a rectangular shape comprised of a tortilla tray exterior portion 310 and a tortilla tray interior portion 312. The tortilla tray exterior portion 310 completely surrounds the tortilla tray interior portion 312. The tortilla tray exterior portion 310 includes shallow bowl-like tortilla supporting cavities. Each shallow bowl-like tortilla supporting cavity 320, 322, 324, 326, 328, 330, 332, 334, of the tortilla tray 300 is a shallow cavity formed in the top wall 314 of the tortilla tray exterior portion 310. The tortilla tray interior portion 312 includes tortilla receiving chambers 342, 344, 346, 348, 350, 352, 354, 356, 358 which are elongated chambers sized and configured to receive soft and hard U-shaped tortillas requiring vertical support. The tortilla receiving chambers 342, 344, 346, 348, 350, 352, 354, 356, 358 are formed in the top wall of the interior tortilla tray portion 312 and are comprised of an interior support sidewall and interior base wall (not shown). The interior support sidewalls (not shown) extend around the interior of each tortilla-receiving chamber and are attached to a base wall. In an alternative embodiment, the tortilla tray interior portion 312 includes shallow bowl-like tortilla supporting cavities and the exterior tray portion 310 includes elongated chambers sized and configured to receive soft and hard U-shaped tortillas requiring vertical support. In another alternative embodiment, the tortilla tray interior tray portion 312 is comprised of a combination of tortilla tray supporting cavities and tortilla tray receiving chambers and the tortilla tray interior portion 312 is comprised of a combination of tortilla tray supporting cavities and tortilla tray receiving chambers.

FIG. 11 illustrates yet another embodiment of a tortilla tray 400. The tortilla tray 400 illustrated in FIG. 11 includes a tortilla tray exterior portion 410 and a tortilla tray interior portion 412. The tortilla tray 400 is a rectangular tray having a tortilla tray interior portion 412 surrounded by a tortilla tray exterior portion 410. The tortilla tray interior portion includes tortilla-receiving chambers 442, 444, 446, 448, 450, 452, 454, 456. Each tortilla-receiving chamber is an elongated chamber sized and configured to receive soft and hard U-shaped tortillas requiring vertical support. Each tortilla-receiving chamber has an interior support sidewall (not shown) extending around its interior and attached to a base wall (not shown). The tortilla tray exterior portion 410 includes a moat-like receiving cavity 460 for receiving condiments that fall off a prepared tortilla. The moat-like receiving cavity 460 may also serve as a storage area and is sectioned off by side walls 421, 423, 425, 427, 429, 431, 433, 435 to create individual storage chambers 441, 443, 445, 447, 449, 451, 453 that may be used for storage of tortilla ingredients.

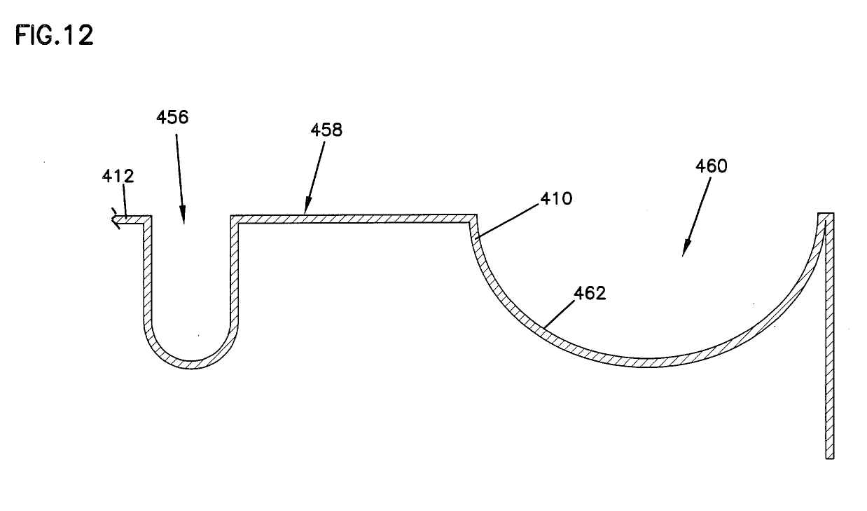

FIG. 12 is a partial sectional view of the tortilla tray 400 shown in FIG. 11 illustrating the moat-like receiving cavity 460 and a tortilla-receiving chamber 456. The interior portion 412 of the tortilla tray 400 is attached to the moat-like receiving cavity 460 by a separation portion 458. The separation portion 458 in the present embodiment is not flexible and provides stationary support for the exterior portion 410 and the moat-like receiving cavity 460. Separation portion 458 is also long enough so that in alternative embodiments, the exterior portion 410 may be hingedly connected to the interior portion 412. Alternatively, the separation portion 458 may be comprised of flexible material and configured such that it performs as a living hinge, thereby allowing the exterior portion 410 to fold downward and upward. In an embodiment in which the separation portion 458 is a living hinge or hingedly connected to the interior portion 412, the tortilla tray exterior portion 410 may be folded downward. If the tortilla tray exterior portion 410 is folded upward, it is hingedly connected in such a manner to allow the exterior portion to lie on top of the interior portion 412.

FIG. 13 illustrates yet another embodiment of a tortilla tray 402. The tortilla tray 402 illustrated in FIG. 13 includes a tortilla tray exterior portion 470 and a tortilla tray interior portion 490. The tortilla tray 402 is a circular tray having a top wall 491, sidewall (not shown) and a bottom wall (not shown). The top wall 491 includes a tortilla tray interior portion 490 surrounded by a tortilla tray exterior portion 470. The tortilla tray interior portion 490 is comprised of a bowl-like cavity for storing tortilla ingredients. The tortilla tray exterior portion 470 includes a plurality of tortilla-receiving chambers 471, 473,475, 477, 479, 481, 483, 485, 487 that are elongated chambers sized and configured to receive soft and hard U-shaped tortillas requiring vertical support. Each tortilla-receiving chamber has an interior support sidewall (not shown) extending around its interior and attached to a base wall (not shown). The tortilla tray exterior portion 470 also includes a plurality bowl-like tortilla supporting cavities 472, 474, 476, 478, 480, 482, 484, 486 and 488. It is contemplated that in an alternative embodiment, the tortilla tray exterior portion 470 includes a plurality of tortilla-receiving chambers only and in another alternative embodiment, the tortilla tray exterior portion 470 includes a plurality of bowl-like tortilla supporting cavities only.

FIG. 14 illustrates yet another embodiment of a tortilla tray 402. The tortilla tray 400 illustrated in FIG. 14 includes a tortilla tray exterior portion 470 and a tortilla tray interior portion 492. The tortilla tray 402 is a circular tray having a top wall 491, sidewall (not shown) and a bottom wall (not shown). The top wall 491 includes a tortilla tray interior portion 492 surrounded by a tortilla tray exterior portion 470. The tortilla tray exterior portion 470 includes a plurality of tortilla-receiving chambers 471, 473, 475, 477, 479, 481, 483, 485, 487 that are elongated chambers sized and configured to receive soft and hard U-shaped tortillas requiring vertical support. Each tortilla-receiving chamber has an interior support sidewall (not shown) extending around its interior and attached to a base wall. The tortilla tray exterior portion 470 also includes a plurality bowl-like tortilla supporting cavities 472, 474, 476, 478, 480, 482, 484, 486 and 488. It is contemplated that in an alternative embodiment, the tortilla tray exterior portion 470 includes a plurality of tortilla-receiving chambers only and in another alternative embodiment, the tortilla tray exterior portion 470 includes a plurality of bowl-like tortilla supporting cavities only.

FIG. 15, illustrates a rotational assembly 370 that engages the tortilla tray illustrated in FIGS. 13 and 14. The rotational assembly 370 illustrated in FIG. 15 is comprised of a base plate 372 and a wheel and spoke assembly 376. The base plate 372 is circular and sized to be substantially the same circumference as the tortilla trays illustrated in FIGS. 13 and 14. The base plate is configured to include a circular grove 374 into which the wheel assembly 376 is positioned. The wheel assembly is comprised of a ring 382, a central post 378 and spokes 379, 381, 383, 385 connecting the ring 382 and central post 378. The ring 382 includes wheels 380 that are attached thereto in such a manner that the ring 382 is suspended above the base plate 372. The wheels are positioned on the base plate 372 within the circular grove 374 allowing the ring 382 to rotate about the axis located at the center of the central post. The central post 378 extends above the plane of the wheels 380 and engages a cavity shaped within the center of the underside of the bottom wall of the tortilla tray 402 illustrated in FIGS. 13 and 14, when the tortilla tray is positioned on top of the rotational assembly. The bottom wall of the tortilla tray rests on the wheels 380. Resting the bottom wall of the tortilla tray 402 on the wheels 380 of the wheel assembly 376 provides the tortilla tray with the means to rotate on the axis centrally located at the central post 378.

An alternative embodiment of the present invention is illustrated in FIG. 16 wherein the tortilla tray 600 is a mini tray having tortilla receiving chambers only. In this embodiment, the tortilla tray 600 is a hard, non-collapsible composite material, preferably plastic, comprised of a first sidewall (not shown) a second sidewall 610 and a top wall 602. The top wall 602 is curved to provide additional support for soft tortillas positioned within the tortilla tray 600. Formed within the top wall 602 are tortilla-receiving chambers 640, 642, 644, 646. Each of the tortilla receiving chambers 640, 642, 644, 646 is an elongated chamber having side walls 620, 622, 624, 626 that extend around the interior of each tortilla receiving chamber 640, 642, 644, 646 that connect to base walls (not shown). Each of the tortilla receiving chambers 640, 642, 644, 646 provides improved support for tortillas supported therein as the curved shape of the top wall 602 allows each tortilla receiving chamber 640, 642, 644, 646 to have taller sidewalls towards the center of each tortilla receiving chamber 640, 642, 644, 646. The taller portions of the side walls towards the center of each tortilla receiving chamber 640, 642, 644, 646 provides improved support so that the sidewalls 620, 622, 624, 626 engage the tortilla at a higher point on the tortilla, thereby increasing the stability and support for the tortilla when positioned within the tortilla receiving chambers 640, 642, 644, 646. An important feature of the tortilla tray 600 illustrated in FIG. 16 is that each tortilla receiving chamber 640, 642, 644, 646 has sidewalls 620, 622, 624, 626 configured such that the sidewalls surround the tortilla at all points. The curved shape of the top wall 602 allows the tortilla receiving chambers 640, 642, 644, 646 to extend above the ends of a tortilla when it is positioned within the tortilla receiving chambers 640, 642, 644, 646 to create a no spill wall 650, 652, 654, 646. The no spill wall 650, 652, 654, 656 allows the tortilla-receiving chamber to keep the tortilla ingredients inside the tortilla when positioned in the tortilla-receiving tray 600.

FIG. 17 is another embodiment of a mini tortilla tray 500 wherein the top wall 510 of the tortilla tray 500 is flat. The tortilla tray 500 includes four sidewalls 502, 504, 506 and 508 and a top wall 510. The top wall 510 has tortilla-receiving chambers 520, 530, 540, 550, 560, 570 formed therein. Within each tortilla-receiving chamber 520, 530, 540, 550, 560, 570 there are interior walls 522, 532, 542, 552, 562, 572 as illustrated in FIG. 18. The interior walls 522, 532, 542, 552, 562, 572 that comprise the tortilla receiving chambers 520, 530, 540, 550, 560, 570 of the tortilla tray 500 are U-shaped and each receiving chamber is abutted up against the next receiving chamber. This embodiment also includes a no spill wall at the first and second ends of each tortilla-receiving chamber 520, 530, 540, 550, 560, and 570. The no spill wall (not shown) allows the tortilla receiving chambers 520, 530, 540, 550, 560, 570 to keep the tortilla ingredients inside the tortilla when positioned in the tortilla-receiving tray 500.

Another embodiment of the present invention illustrated in FIG. 19 is a mini tortilla tray 700 wherein the tortilla-receiving tray 700 includes sidewalls 702, 704, 706, 708 and a top wall 712. Within the top wall 712 are tortilla-receiving chambers 730, 732, 734 formed therein. Each tortilla-receiving chamber 730, 732, 734, 736 has a sidewall 742, which extends down to a base wall (not shown) and around the interior of the entire tortilla-receiving chamber 730. As illustrated with respect to tortilla receiving chamber 730, the sidewall 742 extends around the interior of the entire tortilla receiving chamber 730 and the ends of the tortilla receiving chamber 744, 746 has a collection lip that prevents the ingredients within a tortilla from spilling out of over the side of the tortilla receiving tray 700.

FIG. 20 illustrates yet another embodiment of a tortilla support device 810, illustrated in its extended position and in FIG. 21 in a generally flat storage position. The tortilla support device 810 comprises a first wall 860, a second wall 870 and a top wall 850, respectively. The tortilla support device 810 does not have a bottom surface and would use the table, plate or other support apparatus upon which the tortilla support device 810 would be positioned as its bottom surface. Thus, the sidewalls 860 and 870 of the tortilla support device 810 are integrally coupled to the top plate 850, respectively. The top wall 850 is configured to provide a plurality of tortilla receiving chambers 840, 842, 844 and 846. When the tortilla support device 810 is expanded from its flat position illustrated in FIG. 21 to a partially extended position as illustrated in FIG. 20, tortillas may be supported without attaching the tortilla support device 810 to a table, tray or plate. In the embodiment illustrated in FIG. 20, the length of the top wall 850 is such that when the tortilla support device 810 is partially expanded, the tortilla receiving chambers 840, 842, 844 and 846 are of a size sufficient to receive and support tortillas. In an alternative embodiment, the length of the top wall 850 is such that when the tortilla support device 810 is fully expanded, the tortilla receiving chambers 840, 842, 844 and 846 are of a size sufficient to receive and support tortillas. Accordingly, the tortilla receiving tray tab 880 that has a mild adhesive positioned thereon would be used to allow the tortilla support device 810 to be temporarily attached to a table, tray or plate. The tortilla receiving tray tab 880 attaches sidewall 860 and a second tortilla receiving tray tab (not shown) attaches sidewall 870 to a table, tray or plate and thereby provides the support necessary to allow the top wall 850 to be fully extended from its accordion-like partially extended configuration, illustrated in FIG. 20, so that the top wall 850 is substantially flat. The tortilla support device illustrated in FIGS. 20 and 21 is comprised of paper. Alternatively, the tortilla support device illustrated in FIGS. 20 and 21 may be comprised of a durable, light flexible plastic or other material. The configuration of the tortilla support device 810 allows it to be stored in its generally flat storage position, as shown in FIG. 21 and extended when use is desired. This embodiment allows for a tray to be provided and used in many different venues without very much space utilization. Alternatively, as illustrated in FIG. 22, the tortilla support device 810 may include a base wall 890. The base wall 890 is integrally coupled to sidewalls 860 and 870 and sidewalls 860 and 870 are integrally coupled to the top wall 850, respectively. The length of the top wall 850 is such that when the tortilla support device 810 is fully expanded, the tortilla receiving chambers 840, 842, 844 and 846 are of a size sufficient to receive and support tortillas. The tortilla support device illustrated in FIGS. 20 and 22 is comprised of paper. Alternatively, the tortilla support device illustrated in FIGS. 20 and 22 may be comprised of a durable, light flexible plastic or other material. The configuration of the tortilla support device 810 allows it to be stored in its generally flat storage position, as shown in FIG. 21 and extended when use is desired.

While the invention has been particularly shown and described with reference to preferred embodiments thereof, it will be understood by those skilled in the art that various other changes in the form and details may be made therein without departing from the spirit and scope of the invention. The foregoing description of the exemplary embodiments of the invention has been presented for purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

We claim:

1. A tortilla support tray comprising:
an interior portion, wherein the interior portion includes at least:
a top wall having at least one tortilla receiving chamber formed therein,
wherein the at least one tortilla receiving chamber is comprised of a base wall connected to a sidewall that extends around the interior of the tortilla receiving chamber;
at least one exterior portion connected to the interior portion, wherein the exterior portion includes:
a top wall and sidewalls, wherein the top wall has at least one tortilla-receiving cavity formed therein.

2. The tortilla support device of claim 1, wherein the interior portion includes at least one tortilla-receiving cavity formed in the top wall of the interior portion.

3. The tortilla support device of claim 1, wherein the exterior portion includes at least one tortilla-receiving chamber formed in the top wall of the exterior portion.

4. The tortilla support device of claim 1, wherein the at least one exterior portion is hingedly connected to the interior portion so that the at least one exterior portion folds upward and downward.

5. The tortilla support device of claim 4 is comprised of plastic, wherein the at least one exterior portion is hingedly connected to the interior portion by an integral living hinge.

6. The tortilla support device of claim 1, wherein the at least one exterior portion is removably connected to the interior portion.

7. The tortilla support device of claim 6, wherein the at least one exterior portion is removably connected to the interior portion by a dovetail connector.

8. A tortilla support device comprising:
an interior portion, wherein the interior portion includes at least:
a top wall having at least one tortilla supporting cavity formed therein;
at least one exterior portion connected to the interior portion, wherein the exterior portion includes:
a top wall and sidewalls, wherein the top wall has at least one tortilla-receiving chamber, wherein the at least one tortilla receiving chamber is comprised of a base wall connected to a sidewall that extends around the interior of the tortilla receiving chamber.

9. A tortilla support device comprising:
opposed first and second side walls, opposed third and fourth side walls and a convexly curved top wall connected to the first, second, third and fourth side walls, wherein the convexly curved top wall has tortilla receiving chambers formed therein
wherein the tortilla receiving chambers have an interior wall connected to the top wall and the interior wall extends down from the top wall to create a tortilla receiving chamber, wherein the tortilla receiving chambers are an elongated shape and is sized and configured to receive tortillas, the tortilla receiving chamber having side walls around and throughout the entire cavity and the convexly curved top wall causing the side wall to be lowest at the first and second end of the tortilla receiving chamber and highest at the center of the tortilla receiving chamber;
wherein the sidewall at the first and second end of the tortilla-receiving chamber provide additional support to the tortilla and keeps the tortilla ingredients inside of the tortilla.

10. A tortilla support device comprising:
opposed first and second side walls, opposed third and fourth side walls and a top wall connected to the first, second, third and fourth side walls, wherein the top wall has tortilla receiving chambers formed therein
wherein the tortilla receiving chambers have an interior wall connected to the top wall and the interior wall extends down from the top wall to create a tortilla supporting cavity, wherein the tortilla receiving chambers are of an elongated shape that is sized and configured to receive tortillas, the tortilla receiving chambers have side walls around and throughout the entire cavity,
wherein the side wall at a first end and a second end of the tortilla receiving chamber provide additional support to the tortilla and keeps the tortilla ingredients inside of the tortilla by providing a containment wall at the point on a tortilla where there is no support.

11. The tortilla support device of claim 10, wherein the tortilla receiving chambers are directly adjacent, having no top wall separating each of the tortilla receiving chambers.

12. The tortilla support device of claim 10, wherein the tortilla receiving chambers have an internal U shape.

13. The tortilla support device of claim 10, wherein the tortilla receiving chambers have a sidewall extending down into each of the tortilla receiving chambers to a base wall positioned in parallel to the top wall.

14. A tortilla support device, comprising:
opposing first and second walls;
a first a top wall integrally coupled to the first and second walls, wherein the top wall is pleated and provides for lateral collapsing of the tortilla support device; and
at least one tortilla-receiving slot formed in the top wall for receiving and supporting a tortilla.

15. The tortilla support device of claim 14, wherein the tortilla support device includes a stabilization tab, wherein the stabilization tab includes an adhesive and provides the tortilla support device with a mechanism to temporarily connect the tortilla support device to a surface in an extended position.

16. The tortilla support device of claim 14, wherein the tortilla support device includes a base wall that is pleated and provides for lateral collapsing of the tortilla support device.

17. A rotating tortilla support tray comprising:
a top tray assembly including at least a top wall having a plurality of tortilla receiving chamber formed therein, wherein each one tortilla receiving chamber is comprised of a base wall connected to a sidewall that extends around the interior of the tortilla receiving chamber; and
a base assembly for removably engaging the top tray assembly and enabling the top tray assembly to rotate about a central axis.
